(19) United States
(12) Patent Application Publication
(10) Pub. No.: US 2004/0166205 A1
(43) Pub. Date: Aug. 26, 2004

(54) Gelled foods

(75) Inventor: Rodney O. Nuckles, Vernon, CA (US)

Correspondence Address: FULBRIGHT & JAWORSKI, LLP, 1301 MCKINNEY, SUITE 5100, HOUSTON, TX, 77010-3095, US

(73) Assignee: MARS INCORPORATED, McLean, VA

(21) Appl. No.: 10/373,122

(22) Filed: Feb. 24, 2003

(51) Int. Cl. A23G 1/00

(52) U.S. Cl. 426/100

(57) ABSTRACT

The present invention is directed to a gel enrobed or embedded food product and a process of enrobing or embedding the food product and of using the enrobed food product. The process for enrobing food products includes the steps of: (a) preparing food materials and ingredients to form a food product; (b) preparing a gelling agent to form a gelling solution; (c) placing the food product and gelling solution in a mold; and (d) cooling the food product and gelling solution in order to congeal the gelling solution completely around the food product, forming an enrobed food product. Alternately, the gelling agent can be dissolved in a sauce creating a gel sauce.

### TECHNICAL FIELD

The invention relates to the preparation of food coatings on food products and more particularly to the process of enrobing or coating a food product in a gel mixture or gelling a food mixture.

### BACKGROUND OF THE INVENTION

Film is formed around food products such as seafood, meat, poultry, vegetables, cheese and dough products in order to increase shelf life and improve product integrity. U.S. Pat. No. 3,255,021 and U.S. Pat. No. 3,395,024 to Earle describe the process of using two solutions to form an alginate film which will hold and bind products together and encapsulate them, thereby retarding oxidation, rancidity, dehydration and moisture migration. U.S. Pat. No. 4,504,502 to Earle describes a food product made by applying an aqueous dispersion containing water soluble algin to the surface of a food product, and applying a dry gelling mixture to the algin-coated food product for a period of time sufficient to form a substantially continuous edible film along the surface of the food product. The food product is thereafter treated with batters, breadings, sauces or fillings.

In U.S. Pat. No. 5,595,777, Chalupa describes a process for preparing a gel coated food substrate that includes applying an aqueous batter dispersion to the surface of a food substrate to form a batter-food substrate complex; contacting the batter-food substrate complex with a dry bread material to form a breaded complex; and applying an aqueous gel-forming solution to the breaded batter-food substrate complex to form a thermally irreversible gel film around the complex.

It is an object of the present invention to provide food products and a process of preparing food products quickly that have previously required long preparation and cook times.

It is a further object of the invention to provide food products and a process of preparing food products that will allow the thawing of frozen food products without the need for additional containers.

It is another object of the invention to provide food products that are controlled in size and shape, thus allowing for exact portion control.

It is yet another object of the invention to provide food products and a process of preparing food products in which food dehydration, freezer burn and moisture loss during refrigeration is reduced or inhibited.

### BRIEF SUMMARY OF THE INVENTION

The present invention is directed to a gel enrobed or embedded food product and a process of enrobing or embedding the food product. The process for enrobing food products includes the steps of: (a) preparing food materials and ingredients to form a food product; (b) preparing a gelling agent to form a gelling solution; (c) placing the food product and gelling solution in a mold; and (d) cooling the food product and gelling solution in order to congeal the gelling solution completely around the food product, forming an enrobed food product. Alternately, the gelling agent can be dissolved in a sauce creating a gel sauce.

In another embodiment a gelled food product is formed. This process includes the steps of: (a) preparing food materials and ingredients to form a food product; (b) preparing a gelling agent to form a gelling solution; (c) dipping the food product in the gelling solution; and (d) cooling the dipped food product in order to congeal the gelling solution on the food product, forming a gelled food product.

In a further embodiment, a gelled food product is formed from liquid and semi-liquid food products. This process includes the steps of: (a) preparing liquid or semi-liquid food materials and ingredients to form a food product; (b) dissolving a gelling agent in the food product to create a gel solution; (c) placing the gel solution into a mold; and (d) cooling the gel solution in order to congeal the gel solution, forming a gelled food.

A further embodiment provides for a gel enrobed, embedded or coated food product produced by the inventive process. Alternatively, a gelled food product can be produced by the inventive process.

A further embodiment provides for a method of preparing an enrobed or gel coated food product. The method includes the steps of heating an enrobed or gel coated food product to a selected temperature by means of a heating source and removing the food product from the heating source and serving the food product. Alternatively, a method of preparing a gelled food product, includes the steps of heating a gelled food product to a selected temperature by means of a heating source and removing the food product from the heating source and serving the food product.

Another embodiment for a method of preparing a gelled food product includes the steps of a) heating a gelled food product to a selected temperature by means of a heating source; b) adding other food products to the gelled food product; and c) heating the gelled food product and the other food product by means of the heating source for a selected period of time to form a combined food product; and d) removing the combined food product from the heating source and serving the food product. In the above described methods of using the food product, the heating source can be a microwave oven, a pan placed on a heating element, a conventional oven or a convection oven.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a flow diagram of one embodiment of the subject invention;

FIG. 2 is a flow diagram of an alternate embodiment of the subject invention;

FIG. 3 is a flow diagram of another alternate embodiment of the subject invention; and

FIG. 4 is a flow diagram of another alternate embodiment of the subject invention.

### DETAILED DESCRIPTION OF THE INVENTION

The subject invention is directed to a gel enrobed, gel coated or gelled food product and a process for enrobing, gel coating and gelling the food product and a method of using the inventive food product. The technology of gelled foods has many benefits. Gelled sauces and marinades do not flow therefore they can be handled and stored without a container. Food dehydration, freezer burn and moisture loss during refrigeration of gelled foods is reduced or inhibited. The shelf life of the enrobed or gel covered food products of the subject invention can be extended by the addition of antioxidants, antimicrobials or heavy metal sequestrants to the gel solution. The subject invention provides for improved food safety by providing a fully cooked or retorted food product that only requires minimal heating prior to eating. The enrobed and gel coated food products and the gelled food products reduce the need for expensive packaging.

The aesthetics, such as color and plumpness, of gelled foods are improved over extended periods of frozen storage and freezer cycling versus conventional freezing methods such as Individually Quick Frozen (IQF) foods. Vitamin retention in gelled foods during frozen storage is improved versus conventional freezing methods such as those used to prepare Individually Quick Frozen foods. The subject invention also allows for flavors, spices, herbs and colorants to be added to the gel solution or gel sauce. The food products of the subject invention will exhibit a better flavor profile that traditionally prepared convenience foods.

Gel technology of the subject invention also allows for the invention of food products that are presently not possible with the application of current food technologies. It will enable restaurants to utilise flexible cooking methods and to quickly cook (generally 2 minutes or less) and serve high quality foods that have previously required long preparation and cook times such as “one minute risotto”. Frozen vegetables stored for months will exhibit fresh picked color and frozen foods stored for months will taste freshly cooked. The subject invention also provides for the controlled shape and size of food products, which in turn allows individual portion control of food products that are prepared and served in the restaurant and commercial food industry.

All types of food products can be enrobed, gel coated or gelled. Examples include but are not limited to, sauces and marinades of any type such as a balsamic vinegar marinade, salsas and sweet and sour sauce; soups; meats such as chicken Alfredo, and marinated raw beef steaks; vegetables such as green beans, carrots, broccoli florets and broccoli in cheese sauce; potatoes such as potatoes O'Brien and french fried potatoes; pastas, rices and risottos; deep fried meats such as breaded chicken nuggets; fruits and fruit smoothies; desserts such as cheesecake and berry compote; appetisers; and complete meals such as sweet & sour chicken with rice or a roast beef dinner including sautéed onions, oven baked potato wedges and carrot crosscuts. Food materials used to form the food products include but are not limited to vegetables, cooked and raw meat, poultry and fish, starch ingredients such as pasta, rice, grain products, fruits, sauce and marinade ingredients, and blended fruit drink ingredients, all known to one skilled in the art of food preparation.

The enrobing, gel coating and gelling materials, generally referred to as gelling agents, can be used singly or in combination to produce the enrobed foods of the subject invention. A list of gelling agents includes at least the following compounds: gelatin, pectin, guar gums, carrageenans, konjac, algin, alginates, agar, locust bean gum, acacia gum, methylcellulose gum, carboxymethylcellulose gum, gum arabic hydroxypropylmethylcellulose gum, microcrystalline cellulose gum, furcelleran gum, gellan gum, ghatti gum, karaya gum, tara gum, tragacanth gum, xanthan gum, and other natural gums.

The enrobed, gel coated or gelled food products can be prepared by several different methods. A first method is preferably used to enrobe or embed solid foods 10 such as meat (raw, processed and/or cooked), vegetables (blanched and/or IQF) and so forth. The first method includes several embodiments. A selected gelling agent 12 is solubilized in water 14 to create a mixture called a gelsol 16. A sufficient quantity of gelling agent 12 is used in the gelsol 16 such that over time the gelsol 16 will transform into a gel, which is defined as a jellylike substance formed by cooling a colloidal solution into a solid or semi-solid phase. The gelsol 16 can coat the food 10 with a thin coating or completely surround the entire food product with a layer of gel. In one embodiment, a container 18 (flexible or rigid mold) is selected in which to place the solid food 10 and the gelsol 16. The solid food 10 is placed into the container 18 and an appropriate amount of the gelsol 16 is poured over and around the food 10 to completely surround the food. The amount or thickness of gelsol 16 surrounding the solid food 10 will depend upon the food product being prepared. The gelsol 16 surrounding the solid food 10 becomes solidified at a temperature below the coagulation temperature of the particular gelling agent used to create the gelsol 16. This can take place at room temperature or in either a refrigeration or freezer unit 20. The enrobed or embedded solid food product 22 can remain in the container 18 or alternatively can be removed from the container 18 so as to create a demolded enrobed food product 22A, prior to packaging the enrobed or embedded food product 22, 22A in appropriate packaging 24.

In a second embodiment a sufficient quantity of gelling agent 12 is dissolved in sauce ingredients to create a gel sauce 16A such that over time the gel sauce 16A will transform into a gel. A container 18 (flexible or rigid) is selected in which to place the solid food 10 and the gel sauce 16A. The solid food 10 is placed into the container 18 and an appropriate amount of the gel sauce 16A is poured over and around the food 10 to completely surround the food. The amount and thickness of gel sauce 16A surrounding the solid food 10 will depend upon the food product being prepared. The gel sauce 16A surrounding the solid food 10 becomes solidified at a temperature below the coagulation temperature of the particular gelling agent used in the gel sauce 16A. This can take place at room temperature or in either a refrigeration or freezer unit 20. The enrobed or embedded solid food product 22B can remain in the container 18 or alternatively can be removed from the container 18 so as to create a demolded enrobed food product 22C, prior to packaging the enrobed or embedded food product 22B, 22C in appropriate packaging 24.

In a third embodiment of the first method, a vessel or other container 26 can be used in a thin film coating process in which a thin coating of a gelsol 16 is applied to the food product. In one embodiment a “gelsol bath” is prepared in which a sufficient quantity of gelling agent 12 is used in the gelsol 16 such that over time the gelsol 16 will transform into a gel. The thin film coating processes can include dipping, conveying, or submerging the solid food 10 into the vessel 26 containing the gelsol 16, placing the solid food 10 in a thin film coating drum or spraying or foaming the gelsol 16 on the food product 10. The solid food product 10 is then removed from the thin film coating process in which the thin coating of gelsol 16 surrounding the solid food 10 becomes solidified at a temperature below the coagulation temperature of the particular gelling agent used in the gelsol bath. This can take place at room temperature or in either a refrigeration or freezer unit 20. The gel coated solid food 22D is then packaged in appropriate packaging 24.

A second method is used to gel liquid or semi-solid (viscous) foods 10A such as marinades, sauces, fruit smoothies, and so forth. In this method, a selected gelling agent 12 is mixed and solubilized into the matrix of the liquid or semi-solid food 10A creating a gel solution 16B. The gel solution 16B is placed in a container 18. The percentage of gelling agent 12 mixed into the food 10A is sufficient such that the food 10A will change into a gelled state after a short period of time at a temperature below the coagulation temperature of the particular gelling agent solubilized into the liquid or semi-liquid food 10A. This can take place at room temperature or in either a refrigeration or freezer unit 20. The gelled food product 22E can remain in the container 18 or alternatively can be removed from the container 18 so as to create a demolded gelled food product 22F, prior to packaging the gelled food product 22E, 22F in appropriate packaging 24.

When it is desired to prepare the enrobed or gel coated food product 22 -22D for consumption, the enrobed or gel coated food product is heated to or above the melting temperature of the gelling agent, and depending upon the food product, it is then further heated to the proper temperature and served. The GELLED enrobing gelsol or gel sauce becomes part of the served food product and as such it can be a carrier for ingredients such as flavors, spices, fragrances, colorants, or any other ingredient that can be dissolved in or mixed in with the gelling solution or sauce.

When it is desired to prepare the gelled liquid or semi-liquid food products 22E-F, the gelled food product is heated to or above the melting temperature of the gelling agent, and depending upon the food product, it is then served, used to prepare other foods or further heated to the proper temperature and served.

The enrobed, gel coated or gelled food products 22-22F allows frozen food products to be thawed without having to be placed in a container, because even thawed the enrobed, gel coated or gelled food product maintains its “gelled” state. The enrobing, coating or gelled material does not change from its “gelled” state until the food product is heated to or above the melting temperature of the particular gelling agent used in the enrobing or coating process.

### EXAMPLES

The following ingredient amounts and procedures are exemplary examples only of amounts and procedures that can be used to prepare the gelled food products of the subject invention.

### Example 1

For gelling liquid and or semi-solid (viscous) foods, 0.25 ounces of gelatin is solubilized into 6.0 ounces of a sweet & sour sauce. The sauce is cooled to form a solid “puck-like” form at room temperature. When it is desired to use the sauce in cooking, it can be heated in a pan and cooked with meat or poultry.

### Example 2

For gelling a liquid or semi-liquid (viscous) food such as a hot bacon dressing, during manufacturing of the bacon dressing, the recipe includes 4% gelatin. Upon cooling the dressing forms a solid “puck-like” form at room temperature. When it is desired to prepare the dressing for serving, the gelled puck of dressing is placed on, for example, a wilted spinach salad and is microwaved until the gel melts and the bacon dressing is hot (30-60 sec).

### Example 3

For enrobing or embedding a complete meal, 0.25 ounces of gelatin is solubilized into 6 ounces of water (gelsol). The following amounts of solid food and gelsol are placed in a container or coated with the gelsol and then refrigerated or frozen:

a. 2 ounces of fully cooked meat plus 1 ounce gelsol

b. 2 ounces blanched broccoli plus 2 ounces gelsol

c. 2 oz blanched carrots plus 1 ounce gelsol

d. 2 oz sauteed mushrooms plus 2 ounces of gelsol

When the enrobed or gel coated food product is ready to prepare, it is placed in a microwave oven and heated until the food is hot.

### Example 4

For enrobing or embedding rice or pasta, 0.25 ounce of gelatin is solubilized into 6 ounces of chicken, beef, vegetable, or any other stock (gelstock). The following amounts of rice or pasta are placed in a container with the gelstock and then refrigerated or frozen:

a. 6 ounces of risotto plus 6 ounces of gelstock, or

b. 6 ounces of cooked pasta plus 6 ounces of gelstock

When the enrobed food product is ready to prepare, it is placed in a microwave oven and heated until the food is hot.

### Example 5

For enrobing or embedding solid foods and liquid or semi-solid (viscous) foods together, 0.25 ounces of gelatin is solubilized into 6 ounces of gravy (gelgravy). The following amounts of solid and gelgravy are placed into a container and then refrigerated or frozen:

a. complete roast beef meal (4 ounces oven roasted beef, 3 ounces oven roasted potatoes, 1.50 ounces oven roasted carrots, 0.9 ounces oven roasted white onions enrobed with 4 ounces of gelgravy

b. 3.4 ounces oven roasted vegetables plus 2 ounces gelgravy

c. 4 ounces of oven roasted beef plus 2 ounces gelgravy

When the enrobed food product is ready to prepare, it is placed in a microwave oven and heated until the food is hot.

### Example 6

For enrobing or embedding a stuffed food, such as baked stuffed pork chops, the raw pork chops are stuffed with stuffing (any stuffing that is desired) and baked in an oven until done. The baked stuffed pork chops are rapidly cooled in a cooler and then sprayed with a 4% solution of pork gravy/sauce flavored gelatin and frozen. When the pork chops are ready to prepare, the pork chops are reheated in a pan or microwave and the gelatin melts into a flavored sauce for the pork chop while the pork chop is being reheated.

### Example 7

For enrobing or embedding rice or pasta, such as a white wine parmesan risotto, 4% by weight of gelatin is added to a water/arborrio rice mixture prior to cooking and the arborrio rice is cooked via the risotto process. Upon cooling a gelled puck-shaped risotto product is formed. When the gelled puck-shaped risotto product is ready to serve, it is either microwaved for 1 minute or heated in a skillet containing chicken broth or another liquid and then served.

### Example 8

For enrobing or coating a solid food product such a steamed french cut green beans, french cut IGF green beans are enrobed or coated in a 4% solution of gelatin and then refrigerated or frozen. Upon heating the green beans in either a microwave or sauce pan, the gel solution melts and becomes the heating medium for the beans. Thereafter, the beans are drained of the gel fluid and served

### Example 9

For coating a solid food product such as a berry compote, fresh blackberries, blueberries and red raspberries are lightly sprayed with a 4% gelatin solution and thereafter cooled, resulting in individually gel coated berries. When ready to serve, the gel coated berries are spooned onto a scoop of ice cream, cake or such and microwaved for 15 seconds. The resulting food product is served as “fresh berries” over ice cream or cake.

### Example 10

For gelling a semi-liquid (viscous) food such as nacho cheese sauce, 4% gelatin is added to the nacho cheese sauce recipe during manufacturing of the sauce. Upon cooling the cheese sauce forms a solid “puck-like” shape at room temperature. When ready to serve, the gelled puck of nacho cheese sauce can be placed on chips and then microwaved until the gelled cheese sauce is melted and hot (30-60 sec).

### Example 11

For preparing a multi-component food product, only a portion of the food ingredients need to be enrobed. For example, in the preparation of “bread bowls”, the filling for the bread bowl, such as chicken salad, is enrobed in a gel sauce and placed into a hollowed out loaf of bread. The bread bowl is thereafter packaged and frozen. When ready to serve, the bread bowl is microwaved until the gel sauce has melted and the filling is heated to an appropriate temperature. Due to the enrobing of the filling ingredients, the bread portion of the product does not experience the moisture of the food filling until reheated and therefore does not become soggy during production, distribution and storage.

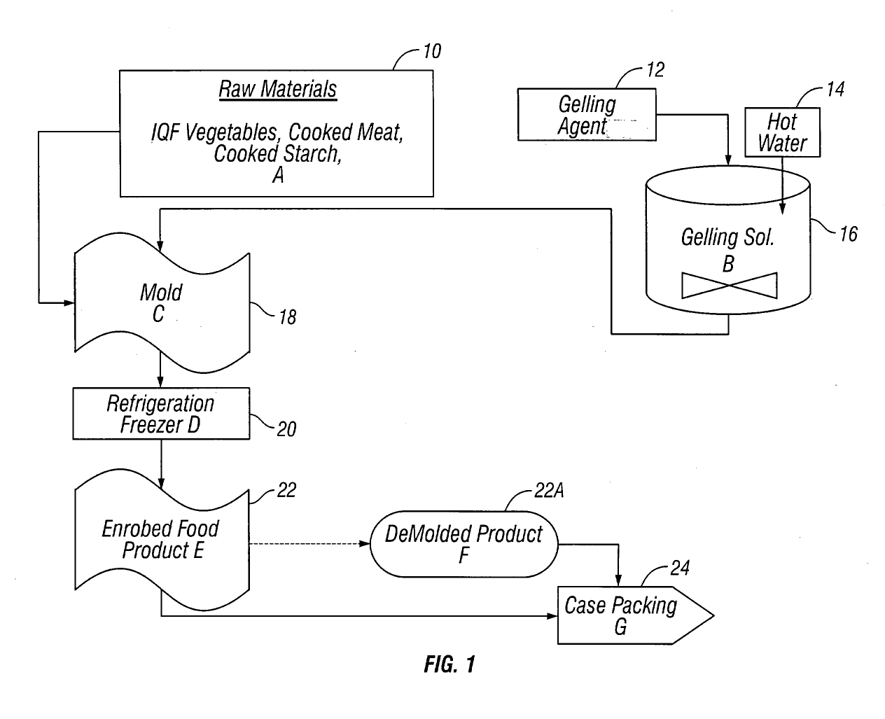

One embodiment of the process of enrobing or embedding a solid food as illustrated in FIG. 1 includes the following steps:

A. Food materials 10 such as IQF vegetables, cooked meats, or cooked starch ingredients are prepared;

B. A gelling agent 12 is dissolved in hot water 14 to create a gel solution 16;

C. The food product 10 and the gel solution 16 is placed into a mold 18;

D. The food product 10 and gel solution 16 is cooled to a congealed state at room temperature or placed in a freezer or refrigeration unit 20;

E. The enrobed or embeded food product 22 is removed from the freezer or refrigeration unit 20, alternatively

F. The enrobed or embedded product 22A is removed from the freezer or refrigeration unit and demolded:

G. The enrobed or embedded food product 22, 22A is packaged 24 for shipping and sale.

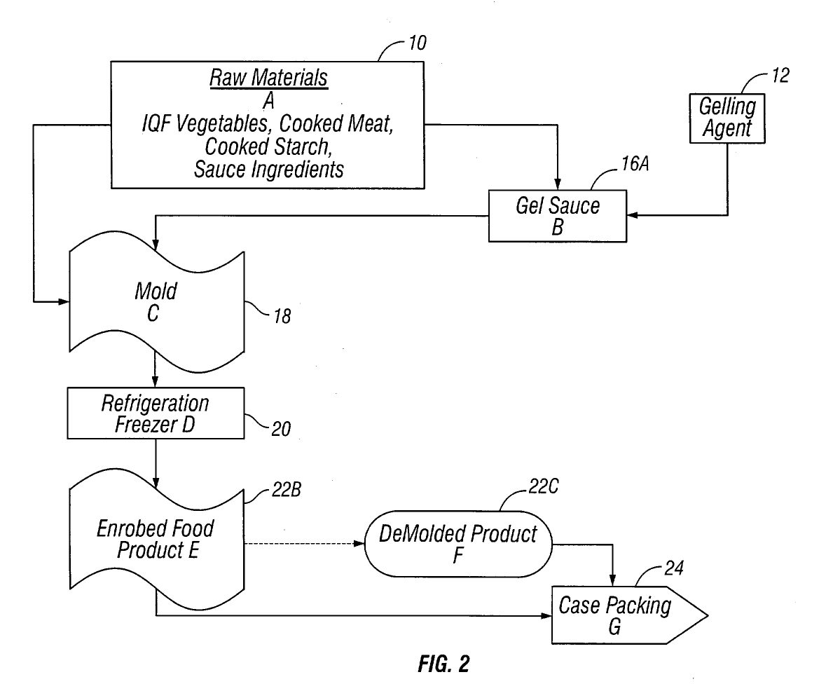

A second embodiment of the process of enrobing or embedding a solid food and sauce as illustrated in FIG. 2 includes the following steps:

A. Food materials 10 such as IQF vegetables cooked meats, or cooked starch, and sauce ingredients are prepared;

B. A gelling agent 12 is dissolved in the sauce ingredients 10 to create a gel sauce 16A;

C. The food products 10 and the gel sauce 16A is placed into a mold 18;

D. The food product and sauce is cooled to a congealed state at room temperature or in a freezer or refrigeration unit 20;

E. The enrobed or embedded food product 22B is removed from the freezer or refrigeration unit; alternatively

F. The enrobed or embedded food product 22C is removed from the freezer or refrigeration unit 20 and demolded;

G. The enrobed or embedded food product 22B, 22C is packaged 24 for shipping and sale.

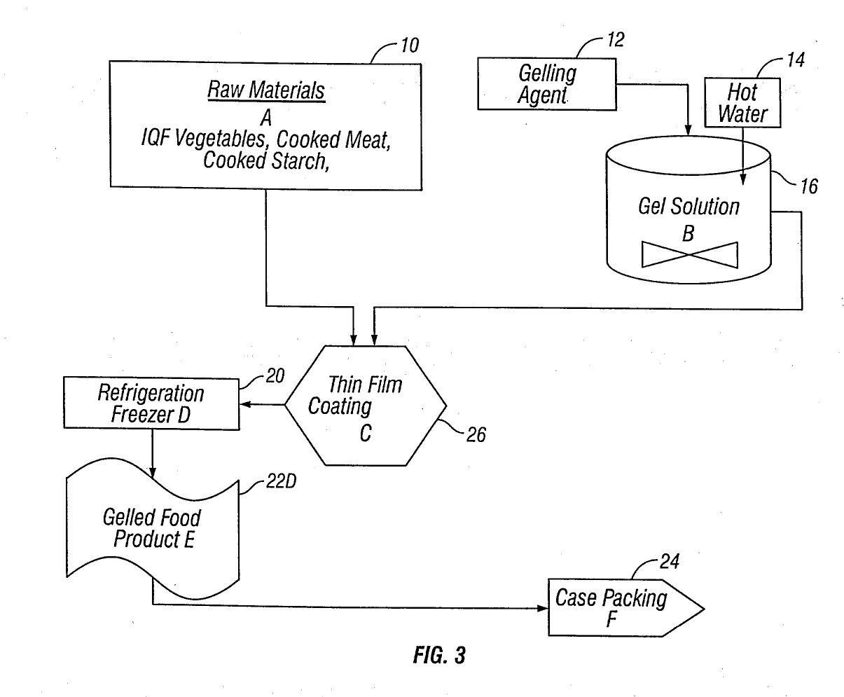

A third embodiment of the process of gel coating a solid food as illustrated in FIG. 3 includes the following steps:

A. Food materials 10 such as IQF vegetables, cooked meats or cooked starch ingredients are prepared;

B. A gelling agent 12 is dissolved in hot water 14 to create a gel solution 16;

C. The food products 10 is gel coated with the gel solution 16 in a thin film coating process in vessel 26;

D. The gel-coated product 22D is cooled to a congealed state at room temperature or in a freezer or refrigeration unit 20;

E. The gel-coated product 22D is packaged 24 for shipping and sale.

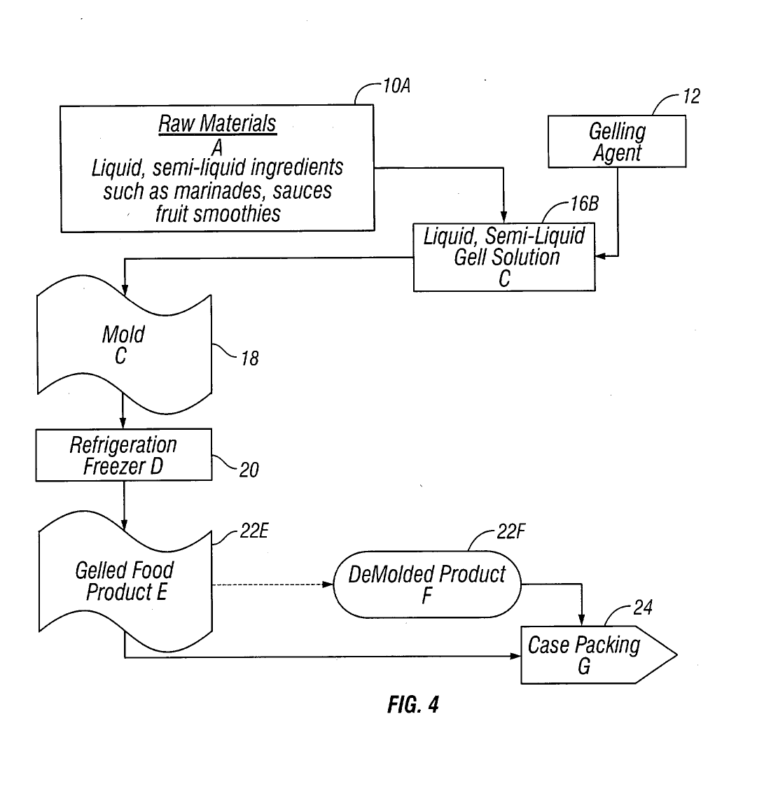

A fourth embodiment of the process of gelling a liquid or semi-liquid food product as illustrated in FIG. 4 includes the following steps:

A. Liquid or semi-liquid food materials 10A such as marinades, sauces or fruit smoothies are prepared;

B. A gelling agent 12 is dissolved in the liquid or semi-liquid food materials 10A to create a gel solution 16B;

C. The gel solution 16B is placed into a mold 18;

D. The gel solution 16B is cooled to a congealed state at room temperature or in a freezer or refrigeration unit 20;

E. The gelled food product 22E is removed from the freezer or refrigeration unit 20; alternatively

F. The gelled food 22F product is removed from the freezer or refrigeration unit 20 and demolded;

H. The gelled food product 22E, 22F is packaged 24 for shipping and sale.

The present invention provides food products and a process of preparing food products quickly that have previously required long preparation and cook times. It also allows the thawing of frozen food products without the need for additional containers. The present invention further provides food products and a process of preparing food products in which food dehydration, freezer burn and moisture loss during refrigeration is reduced or inhibited.

The present invention allows restaurants to prepare and serve food products quickly, generally 2 minutes or less, that have previously required long preparation and cook times. Thus allowing food serve operations to reduce labor costs, reduce the skill level of the kitchen staff, serve food items not previously possible, and reduce the wait time of customers.

The present invention further provides for the controlled size and shape of prepared food products which in turn allows for individual portion control. This will provide for a consistent quality of food products and a known cost and size of individual food portions for the restaurant and commercial food industry.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A process for enrobing food products comprising the steps of:
(a) preparing food materials and ingredients to form a food product;
(b) preparing a gelling agent to form a gelling solution;
(c) placing the food product and gelling solution in a mold;
(d) cooling the food product and gelling solution in order to congeal the gelling solution completely around the food product, wherein an enrobed food product is formed.

2. The process of claim 1, wherein a refrigeration or freezer unit is used in the cooling step.

3. The process of claim 1, wherein the food materials include food materials selected from a group comprising vegetables, potatoes, cooked and raw meat, cooked and raw poultry, cooked and raw fish, pasta, rice, grain products, fruits, and sauce, marinade and blended fruit drink ingredients.

4. The process of claim 1, wherein the food products are selected from a group comprising marinades, sauces, soups, chicken Alfredo, marinated raw beef steaks, broccoli florets in cheese sauce, potatoes O'Brien, french fried potatoes, pastas in sauces, rice dishes, risottos, breaded chicken nuggets, fruit smoothies, salsas, desserts and appetisers.

5. The process of claim 4, wherein the food product comprises a complete meal such as a meat or poultry in a sauce, a vegetable and potatoes or rice.

6. The process of claim 1, wherein the gelling agent is selected from a group comprising gelatin, pectin, guar gums, carrageenans, konjac, algin, alginates, agar, locust bean gum, acacia gum, methylcellulose gum, carboxymethylcellulose gum, gum arabic hydroxypropylmethylcellulose gum, microcrystalline cellulose gum, furcelleran gum, gellan gum, ghatti gum, karaya gum, tara gum, tragacanth gum, xanthan gum, and other natural gums.

7. The process of claim 1, wherein the gelling solution includes ingredients selected from a group comprising flavors, spices, fragrances, and colorant.

8. The process of claim 1, further including the step of packaging the enrobed food product for shipping and sale.

9. The process of claim 8, further including the step of demolding the enrobed food product prior to packaging the enrobed food product for shipping and sale.

10. A process for enrobing food products comprising the steps of:
(a) preparing food materials and ingredients to form a food product;
(b) preparing a sauce from sauce ingredients;
(c) dissolving a gelling agent in the sauce to form a gel sauce;
(d) placing the food product and gel sauce in a mold;
(e) cooling the food product and gel solution in order to congeal the gelling solution completely around the food product, wherein an enrobed food product is formed.

11. The process of claim 10, wherein a refrigeration or freezer unit is used in the cooling step.

12. The process of claim 10, wherein the food materials include food materials selected from a group comprising vegetables, potatoes, cooked and raw meat, cooked and raw poultry, cooked and raw fish, pasta, rice, grain products, fruits, and sauce, marinade and blended fruit drink ingredients.

13. The process of claim 10, wherein the food products are selected from a group comprising marinades, sauces, soups, chicken Alfredo, marinated raw beef steaks, broccoli florets in cheese sauce, potatoes O'Brien, french fried potatoes, pastas in sauces, rice dishes, risottos, breaded chicken nuggets, fruit smoothies, salsas, desserts and appetisers.

14. The process of claim 10, wherein the food product comprises a complete meal such as a meat or poultry in a sauce, a vegetable and potatoes or rice.

15. The process of claim 10, wherein the gelling agent is selected from a group comprising gelatin, pectin, guar gums, carrageenans, konjac, algin, alginates, agar, locust bean gum, acacia gum, methylcellulose gum, carboxymethylcellulose gum, gum arabic hydroxypropylmethylcellulose gum, microcrystalline cellulose gum, furcelleran gum, gellan gum, ghatti gum, karaya gum, tara gum, tragacanth gum, xanthan gum, and other natural gums.

16. The process of claim 10, wherein the gelling solution includes ingredients selected from a group comprising flavors, spices, fragrances, and colorant.

17. The process of claim 10, further including the step of packaging the enrobed food product for shipping and sale.

18. The process of claim 17, further including the step of demolding the enrobed food product prior to packaging the enrobed food product for shipping and sale.

19. A process for gel coating food products comprising the steps of:
(a) preparing food materials and ingredients to form a food product;
(b) preparing a gelling agent to form a gelling solution;
(c) coating the food product with the gelling solution;
(d) cooling the coated food product in order to congeal the gelling solution on the food product, wherein a gel coated food product is formed.

20. The process of claim 19, wherein a refrigeration or freezer unit is used in the cooling step.

21. The process of claim 19, wherein the food materials include food materials selected from a group comprising vegetables, potatoes, cooked and raw meat, cooked and raw poultry, cooked and raw fish, and fruits.

22. The process of claim 19, wherein the gelling agent is selected from a group comprising gelatin, pectin, guar gums, carrageenans, konjac, algin, alginates, agar, locust bean gum, acacia gum, methylcellulose gum, carboxymethylcellulose gum, gum arabic hydroxypropylmethylcellulose gum, microcrystalline cellulose gum, furcelleran gum, gellan gum, ghatti gum, karaya gum, tara gum, tragacanth gum, xanthan gum, and other natural gums.

23. The process of claim 19, wherein the gelling solution includes ingredients selected from a group comprising flavors, spices, fragrances, and colorant.

24. The process of claim 19, further including the step of packaging the gelled food product for shipping and sale.

25. A process for gelling food products comprising the steps of:
(a) preparing liquid or semi-liquid food materials and ingredients to form a food product;
(b) dissolving a gelling agent in the food product to create a gel solution;
(c) placing the gel solution into a mold;
(d) cooling the gel solution in order to congeal the gel solution, wherein a gelled food product is formed.

26. The process of claim 25, wherein a refrigeration or freezer unit is used in the cooling step.

27. The process of claim 25, wherein the food materials include food materials selected from a group comprising fruits, sauce and marinade ingredients, and blended fruit drink ingredients.

28. The process of claim 25, wherein the food products are selected from a group comprising sauces, marinades and fruit smoothies.

29. The process of claim 25, wherein the gelling agent is selected from a group comprising gelatin, pectin, guar gums, carrageenans, konjac, algin, alginates, agar, locust bean gum, acacia gum, methylcellulose gum, carboxymethylcellulose gum, gum arabic hydroxypropylmethylcellulose gum, microcrystalline cellulose gum, furcelleran gum, gellan gum, ghatti gum, karaya gum, tara gum, tragacanth gum, xanthan gum, and other natural gums.

30. The process of claim 25, wherein the gel solution includes ingredients selected from a group comprising flavors, spices, fragrances, and colorant.

31. The process of claim 25, further including the step of packaging the gelled food product for shipping and sale.

32. The process of claim 30, further including the step of demolding the gelled food product prior to packaging the gelled food product for shipping and sale.

33. An enrobed food product produced by a process comprising the steps of:
(a) preparing food materials and ingredients to form a food product;
(b) preparing a gelling agent to form a gelling solution;
(c) placing the food product and gelling solution in a mold;
(d) cooling the food product and gelling solution in order to congeal the gelling solution completely around the food product, wherein an enrobed food product is formed.

34. The food product of claim 33, wherein a refrigeration or freezer unit is used in the cooling step.

35. The food product of claim 33, wherein the food materials include food materials selected from a group comprising vegetables, potatoes, cooked and raw meat, cooked and raw poultry, cooked and raw fish, pasta, rice, grain products, fruits, and sauce, marinade and blended fruit drink ingredients.

36. The food product of claim 33, wherein the food product is selected from a group comprising marinades, sauces, soups, chicken Alfredo, marinated raw beef steaks, broccoli florets in cheese sauce, potatoes O'Brien, french fried potatoes, pastas in sauces, rice dishes, risottos, breaded chicken nuggets, fruit smoothies, salsas, desserts and appetisers.

37. The food product of claim 33, wherein the food product comprises a complete meal such as a meat or poultry in a sauce, a vegetable and potatoes or rice.

38. The food product of claim 33, wherein the gelling agent is selected from a group comprising gelatin, pectin, guar gums, carrageenans, konjac, algin, alginates, agar, locust bean gum, acacia gum, methylcellulose gum, carboxymethylcellulose gum, gum arabic hydroxypropylmethylcellulose gum, microcrystalline cellulose gum, furcelleran gum, gellan gum, ghatti gum, karaya gum, tara gum, tragacanth gum, xanthan gum, and other natural gums.

39. The food product of claim 33, the process further including the step of packaging the enrobed food product for shipping and sale.

40. The food product of claim 39, the process further including the step of demolding the enrobed food product prior to packaging the enrobed food product for shipping and sale.

41. An enrobed food product produced by a process comprising the steps of:
(a) preparing food materials and ingredients to form a food product;
(b) preparing a sauce from sauce ingredients;
(c) dissolving a gelling agent in the sauce to form a gel sauce;
(d) placing the food product and gel sauce in a mold;
(e) cooling the food product and gel solution in order to congeal the gelling solution completely around the food product, wherein an enrobed food product is formed.

42. The food product of claim 41, wherein a refrigeration or freezer unit is used in the cooling step.

43. The food product of claim 41, wherein the food materials include food materials selected from a group comprising vegetables, potatoes, cooked and raw meat, cooked and raw poultry, cooked and raw fish, pasta, rice, grain products, fruits, and sauce, marinade and blended fruit drink ingredients.

44. The food product of claim 41, wherein the food product is selected from a group comprising marinades, sauces, soups, chicken Alfredo, marinated raw beef steaks, broccoli florets in cheese sauce, potatoes O'Brien, french fried potatoes, pastas in sauces, rice dishes, risottos, breaded chicken nuggets, fruit smoothies, salsas, desserts and appetisers.

45. The food product of claim 41, wherein the food product comprises a complete meal such as a meat or poultry in a sauce, a vegetable and potatoes or nice.

46. The food product of claim 41, wherein the gelling agent is selected from a group comprising gelatin, pectin, guar gums, carrageenans, konjac, algin, alginates, agar, locust bean gum, acacia gum, methylcellulose gum, carboxymethylcellulose gum, gum arabic hydroxypropylmethylcellulose gum, microcrystalline cellulose gum, furcelleran gum, gellan gum, ghatti gum, karaya gum, tara gum, tragacanth gum, xanthan gum, and other natural gums.

47. The food product of claim 41, the process further including the step of packaging the enrobed food product for shipping and sale.

48. The food product of claim 47, the process further including the step of demolding the enrobed food product prior to packaging the enrobed food product for shipping and sale.

49. A gel coated food product produced by a process comprising the steps of:
(a) preparing food materials and ingredients to form a food product;
(b) preparing a gelling agent to form a gelling solution;
(c) coating the food product with the gelling solution;
(d) cooling the coated food product in order to congeal the gelling solution on the food product, wherein a gel coated food product is formed.

50. The food product of claim 49, wherein a refrigeration or freezer unit is used in the cooling step.

51. The food product of claim 49, wherein the food materials include food materials selected from a group comprising vegetables, potatoes, cooked and raw meat, cooked and raw poultry, cooked and raw fish, and fruits.

52. The food product of claim 49, wherein the gelling agent is selected from a group comprising gelatin, pectin, guar gums, carrageenans, konjac, algin, alginates, agar, locust bean gum, acacia gum, methylcellulose gum, carboxymethylcellulose gum, gum arabic hydroxypropylmethylcellulose gum, microcrystalline cellulose gum, furcelleran gum, gellan gum, ghatti gum, karaya gum, tara gum, tragacanth gum, xanthan gum, and other natural gums.

53. The food product of claim 49, the process further including the step of packaging the gelled food product for shipping and sale.

54. A gelled food product produced by a process comprising the steps of:
(a) preparing liquid or semi-liquid food materials and ingredients to form a food product;
(b) dissolving a gelling agent in the food product to create a gel solution;
(c) placing the gel solution into a mold;
(d) cooling the gel solution in order to congeal the gel solution, wherein a gelled food product is formed.

55. The food product of claim 54, wherein a refrigeration or freezer unit is used in the cooling step.

56. The food product of claim 54, wherein the food materials include food materials selected from a group comprising fruits, sauce and marinade ingredients, and blended fruit drink ingredients.

57. The food product of claim 54, wherein the food product is selected from a group comprising sauces, marinades and fruit smoothies.

58. The food product of claim 54, wherein the gelling agent is selected from a group comprising gelatin, pectin, guar gums, carrageenans, konjac, algin, alginates, agar, locust bean gum, acacia gum, methylcellulose gum, carboxymethylcellulose gum, gum arabic hydroxypropylmethylcellulose gum, microcrystalline cellulose gum, furcelleran gum, gellan gum, ghatti gum, karaya gum, tara gum, tragacanth gum, xanthan gum, and other natural gums.

59. The food product of claim 54, the process further including the step of packaging the gelled food product for shipping and sale.

60. The food product of claim 59, the process further including the step of demolding the gelled food product prior to packaging the gelled food product for shipping and sale.

61. A method of preparing an enrobed food product, comprising the steps of:
a) heating an enrobed food product to a selected temperature by means of a heating source;
b) removing the enrobed food product from the heating source and serving the food product.

62. The method of claim 61, where in the heating source is selected from a group comprising a microwave oven, a conventional oven and a convection oven.

63. A method of preparing a gelled food product, comprising the steps of:
a) heating a gelled food product to a selected temperature by means of a heating source;
b) removing the gelled food product from the heating source and serving the food product.

64. The method of claim 63, where in the heating source is selected from a group comprising a microwave oven, a conventional oven and a convection oven.

65. A method of preparing a gelled food product, comprising the steps of:
a) heating a gelled food product to a selected temperature by means of a heating source;
b) adding other food products to the gelled food product;
c) heating the gelled food product and the other food product by means of the heating source for a selected period of time to form a combined food product.

66. The method of claim 65, wherein the heating source is selected from a group comprising a pan placed on a heating element, a conventional oven and a convection oven.
